(19) United States
(12) Patent Application Publication
(10) Pub. No.: US 2026/0138008 A1
(43) Pub. Date: May 21, 2026

(54) DISPLAY APPARATUS AND CONTROL METHOD THEREOF

(71) Applicant: SAMSUNG ELECTRONICS CO., LTD., Suwon-si (KR)

(72) Inventors: Yoonjae SUNG, Suwon-si (KR); Beomgeun CHU, Suwon-si (KR); Donghwa LIM, Suwon-si (KR); Hoseong SEO, Suwon-si (KR); Hyuntaek NA, Suwon-si (KR)

(73) Assignee: SAMSUNG ELECTRONICS CO., LTD., Suwon-si (KR)

(21) Appl. No.: 19/411,711

(22) Filed: Dec. 8, 2025

Related U.S. Application Data
(63) Continuation of application No. PCT/KR2025/015980, filed on Oct. 10, 2025.

(30) Foreign Application Priority Data
Nov. 15, 2024 (KR) 10-2024-0163128

(51) Int. Cl. A63F 13/28; G06V 10/70; G09G 3/20

(52) U.S. Cl. CPC A63F 13/28; G09G 3/2003; G06V 10/70; G09G 2320/0626; G09G 2320/103; G09G 2340/0435

(57) ABSTRACT

A display apparatus may include: a display; a lighting device including a plurality of light emitting elements configured to emit light from a lower end of the display apparatus; a memory configured to store at least one instruction; and one or more processors configured to execute the at least one instruction to: control the display to display an image input to the one or more processors, sense an object in the displayed image, obtain position information and color information corresponding to the sensed object, and control the lighting device so that at least one light emitting element, among the plurality of light emitting elements, that is at a location of the lower end of the display apparatus that corresponds to the obtained position information emits light of a color corresponding to the obtained color information.

### CROSS-REFERENCE TO RELATED APPLICATIONS

This application is a continuation of International Application No. PCT/KR2025/015980 designating the United States, filed on Oct. 10, 2025, in the Korean Intellectual Property Receiving Office and claiming priority to Korean Patent Application No. 10-2024-0163128, filed on Nov. 15, 2024, in the Korean Intellectual Property Office, the disclosures of each of which are incorporated by reference herein in their entireties.

### TECHNICAL FIELD

This disclosure relates to a display apparatus providing a lighting effect in association with displayed contents and a control method thereof.

### BACKGROUND ART

In recent years, display apparatuses disposed on the lateral surface or rear surface of apparatuses and provided with LEDs emitting light of various colors have been provided. Such display apparatuses may emit light (ambient light) of a main color sensed by users through contents, thereby enabling the users to be deeply immersed in the contents.

### DISCLOSURE OF INVENTION

### Solution to Problem

Embodiments according to the present disclosure are to solve at least one problem and/or disadvantage described above and provide advantages described hereafter. The embodiments according to the present disclosure are to provide a display apparatus providing a lighting effect in association with displayed contents, and a control method thereof.

Additional embodiments may be suggested based on the detailed description provided hereafter, and while some of the embodiments may be clearly understood from the detailed description, other embodiments may also be suggested from the embodiments suggested herein based on learning.

In accordance with the present disclosure, a display apparatus may include: a display; a lighting device including a plurality of light emitting elements that may be configured to emit light from a lower end of the display apparatus; a memory that may be configured to store at least one instruction; and one or more processors that may be configured to execute the at least one instruction to: control the display to display an image input to the one or more processors, sense an object in the displayed image, obtain position information and color information corresponding to the sensed object, and control the lighting device so that at least one light emitting element, among the plurality of light emitting elements, that is at a location of the lower end of the display apparatus that corresponds to the obtained position information emits light of a color corresponding to the obtained color information.

The memory may be further configured to store information about an object of interest respectively corresponding to each game type among a plurality of game types, and the one or more processors may be further configured to: obtain a game type corresponding to the displayed image, and determine whether the sensed object corresponds to the stored information about the object of interest of the obtained game type.

The information about the object of interest may include: shape information of the object of interest, and color information of an object of interest, and the one or more processors may be further configured to: based on a determination that the sensed object corresponds to the stored information about the object of interest, obtain color information about the sensed object.

The display apparatus may further include: a user interface that may be configured to receive a selection of the game type corresponding to displayed image.

The one or more processors may be further configured to: divide the displayed image into a plurality of areas, identify whether the sensed object is present in one or more areas among the plurality of areas, and based on an identification that the sensed object is in the one or more areas, obtain position information corresponding to the one or more areas as the obtained position information.

The one or more processors may be further configured to: compare a previous frame of the displayed image and a current frame of the displayed image to determine an area of the displayed image where the displayed image has changed between the previous frame and the current frame, and determine whether the sensed object is present in the area of the displayed image where the displayed image has changed.

The one or more processors may be further configured to: input the divided image to a learning model that may be configured to identify an object, and based on an output of the learning model indicating that the sensed object may be present, identify a presence of the sensed object.

The memory may be further configured to store a plurality of learning models respectively corresponding to each game type among a plurality of game types, and the one or more processors may be further configured to: obtain a game type corresponding to the displayed image, and perform object recognition with a learning model among the plurality of learning models that corresponds to the obtained game type.

The one or more processors may be further configured to: identify a moving direction of the sensed object, and control the lighting device so that a light emitting element, among the plurality of light emitting elements, that is at a location of the lower end of the display apparatus that corresponds to the identified moving direction emits light.

The one or more processors may be further configured to: identify a position of the sensed object on the displayed image, and control the lighting device so that a light emitting element, among the plurality of light emitting elements, that is at a location of the lower end of the display apparatus that corresponds to the identified position emits light.

The display apparatus may further include: a speaker, wherein the one or more processors may be further configured to: obtain acoustic data input to the speaker, and based on a determination that a sound is present in the obtained acoustic data, control the lighting device to emit light of a color or at a location of the lower end of the display apparatus that corresponds to the sound.

The one or more processors may be further configured to: obtain a direction of the sound, and control the lighting device so that at least one light emitting element, among the plurality of light emitting elements, that corresponds to the obtained direction emits light.

The display apparatus may further include: at least one second light emitting element that may be configured to emit light from a rear surface of the display apparatus, and the one or more processors may be further configured to: control the lighting device and the at least one second light emitting element to emit light together.

In accordance with the present disclosure, a method of a display apparatus including a display, a lighting device including a plurality of light emitting elements that may be configured to emit light from a lower end of the display apparatus, a memory that may be configured to store at least one instruction, and one or more processors that may be configured to execute the at least one instruction, may include: by the one or more processors, controlling the display to display an image input to the one or more processors, sensing an object in the displayed image, obtaining position information and color information corresponding to the sensed object, and controlling the lighting device so that at least one light emitting element, among the plurality of light emitting elements, that is at a location of the lower end of the display apparatus that corresponds to the obtained position information emits light of a color corresponding to the obtained color information.

The control method may further include pre-storing information on an object of interest based each game type, and the sensing a predefined object in an image may include obtaining a game type corresponding to the image, and sensing whether an object of interest corresponding to the obtained game type is present in the image.

The sensing whether an object of interest may include dividing the image into a plurality of areas, and sensing whether a predefined object is present based on each divided area, and the obtaining a game type corresponding to the image may include, based on identifying an object in a specific area, obtain position information corresponding to the area.

The sensing whether an object of interest may include comparing a previous frame and a current frame, and sensing whether an object is present in an area with significant changes between frames.

The generating control information may include obtaining a moving direction of the sensed object, and generating control information such that a light emitting element belonging to a lower end area corresponding to the identified moving direction emits light.

The control method may further include, based on obtaining acoustic data, sensing a predefined sound in the obtained acoustic data, and generating control information to emit light corresponding the sensed sound.

In accordance with the present disclosure, a non-transitory computer readable recording medium storing a program for executing a method of a display apparatus including a display, a lighting device including a plurality of light emitting elements that may be configured to emit light from a lower end of the display apparatus, may include: sensing an object in an image to be displayed on the display of the display apparatus; obtaining position information and color information corresponding to the sensed object; and generating control information that may be configured to control the lighting device so that at least one light emitting element, among the plurality of light emitting elements, that is at a location of the lower end of the display apparatus that corresponds to the obtained position information emits light of a color corresponding to the obtained color information.

### BRIEF DESCRIPTION OF DRAWINGS

Above-describe aspects, features and advantages or other aspects, features and advantages according to embodiments of the disclosure may be understood more clearly from following descriptions provided with reference to accompanying drawings, wherein:

FIG. 1 is a view provided to explain a lighting control operation according to one embodiment;

FIG. 2 is a block diagram illustrating a configuration of a display apparatus according to one embodiment;

FIG. 3 is a block diagram illustrating a configuration of a display apparatus according to one embodiment;

FIG. 4 is a view provided to explain various light emitting positions according to the disclosure;

FIG. 5 is a view provided to explain an operation example of a lighting device according to one embodiment;

FIG. 6 is a view provided to explain an operation example of a lighting device according to one embodiment;

FIG. 7 is a view provided to explain an operation example of a lighting device according to one embodiment;

FIG. 8 is a view provided to explain an operation example of a lighting device according to one embodiment;

FIG. 9 is a view provided to explain an operation example of a lighting device according to one embodiment;

FIG. 10 is a view illustrating an example of a user interface window for receiving a setting of a game genre according to one embodiment;

FIG. 11 is a view illustrating an example of a user interface window for receiving a setting of color information according to one embodiment;

FIG. 12 is a flowchart provided to explain a control method of a display apparatus according to one embodiment; and

FIG. 13 is a flowchart provided to explain a lighting control method according to one embodiment.

### MODE FOR INVENTION

Embodiments of the present disclosure may be modified in various different forms, and may vary. Accordingly, specific embodiments are illustrated in the drawings, and specifically described in the detailed description. However, it is to be understood that the scope of the disclosure is not limited to the specific ones and that embodiments of the disclosure are to be interpreted as including various modifications, equivalents and/or alternatives of the embodiments set forth herein. In the drawings, like reference numerals may be used to indicate like elements.

In describing the disclosure, in case detailed descriptions of known functions or configurations to which the disclosure pertains make the gist of the disclosure unnecessarily vague, detailed description thereof is avoided.

The embodiments described hereafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

Terms set forth herein are merely used to describe specific embodiments, and are not intended to limit the scope of the rights for which protection is sought. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and do not imply exclusion of the presence of additional features.

In the disclosure, expressions such as “A or B,” “at least one of A or/and B,” or “one or more of A or/and B”, and the like may include all possible combinations of items listed together. For example, “A or B,” “at least one of A and B,” or “at least one of A or B” may refer to all cases including (1) at least one A, (2) at least one B, or (3) both of at least one A and at least one B.

In the disclosure, expressions such as “1st”, “2nd”, “first”, or “second”, and the like may be used to refer to various elements regardless of their order and/or importance, and may be merely used to differentiate one element from another but not intended to limit the elements.

Based on one element (e.g., a first element) referred to as being “(operatively or communicatively) coupled with/to or connected with/to” another element (e.g., a second element), it is to be understood that one element may be connected to another element directly or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

The expression “configured to (or set to)” used herein may be used interchangeably with, for example, “suitable for,” “having the capacity to,” “designed to,” “adapted to,” “made to,” or “capable of” depending on circumstances. The term “configured to (or set to)” may not necessarily mean “specifically designed to” in a hardware manner.

Rather, in a certain situation, the expression “a device configured to” may mean “capable of performing” by the device together with another device or other components. For example, the phrase “a processor configured (or set) to perform A, B and C” may mean an exclusive processor (e.g., an embedded processor) for performing the functions, or a generic-purpose processor (e.g., a CPU or an application processor) capable of performing the functions by executing one or more software programs stored in a memory device.

In the embodiments, the term “module” or “unit” may perform at least one function or operation, and be implemented by hardware or software or by a combination of hardware and software. multiple “modules” or multiple “units” may be integrated into at least one module and be implemented with one or more processors except for a “module” or a “unit” that needs to be implemented by specific hardware.

Operations performed by a module, a program, or another element, according to the embodiments, may be executed sequentially, in parallel, repetitively, or heuristically, or at least part of the operations may be executed in a different order, may be omitted, or may add a different operation.

Meanwhile, various elements and regions in the drawings are schematically illustrated. Accordingly, the technical spirit of the disclosure is not limited by relative sizes or distances illustrated in the accompanying drawings.

Meanwhile, an electronic apparatus according to the embodiments of the disclosure may include at least one of a smart phone, a tablet PC, a desktop PC, a laptop PC, a server, or a wearable device, for example. The wearable device may include at least one of an accessory-type wearable device (e.g., a watch, a ring, a bracelet, an anklet, a necklace, glasses, contact lenses or a head-mounted device (HMD)), a fabric or cloth-integrated wearable device (e.g., electronic cloth), a body-attachable wearable device (e.g., a skin pad or tattoo), or implantable circuitry.

In some embodiments, the electronic apparatus, for example, may include at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, or an electronic picture frame. Meanwhile, among the above-described electronic apparatuses, a device provided with a display may be referred to as a display apparatus. Meanwhile, the electronic apparatus according to the disclosure may be a set-top box or a PC that provides an image to a display apparatus, although the electronic apparatus is not provided with a display apparatus.

Hereafter, the embodiments of the disclosure are described specifically with reference to the accompanying drawings such that those skilled in the art to which the disclosure pertains may readily implement the embodiments.

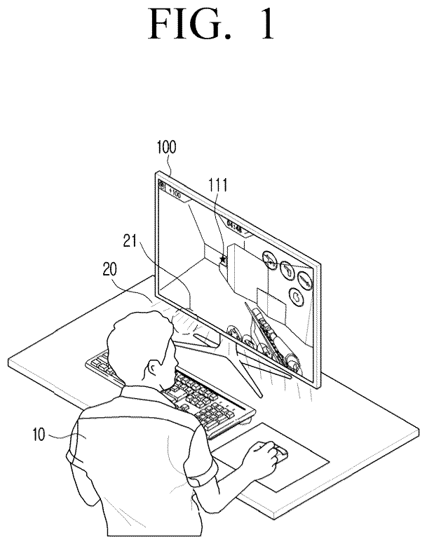

FIG. 1 is a view provided to explain a lighting control operation according to one embodiment.

Referring to FIG. 1, a display apparatus 100 may display an image corresponding to contents to the user 10. Herein, the contents are comprised of images, audios or a combination thereof, and includes information that may be provided, to the user, visually, acoustically, or audiovisually through an electronic apparatus. The contents, for example, may include game contents, voice contents, music contents, image contents, moving image contents, widget contents, webpages and the like.

The display apparatus 100 may be implemented as various types of devices such as a digital TV, a DVD player, a blue-ray disc player, a game console, a network TV, a smart TV, an Internet TV, a web TV, an Internet Protocol television (IPTV), a Signage, a PC, a head-mounted display (HMD, a wearable device), and the like, but not limited thereto.

The latest display apparatus may be provided with a lighting device, and control the provided lighting device to provide, to the user, a fancy and stylish environment when a display is used. For example, lighting in association with an image is output by using lighting (a light emitting element) disposed on the rear surface or the lateral surface and the like of the display apparatus, enabling the user to be more deeply immersed in the contents.

However, in the case of control of existing lighting, main colors in an image are only considered or predetermined colors are used, providing a limited immersion feeling to the user. In particular, when it comes to game contents, there may be various objects of interest and areas of interest, but lighting adaptive to various situations, i.e., a situation of an object on a screen, may not be provided.

To solve the problem, according to the disclosure, an object (or an area) in which the user may be interested is probably identified in an image, and a lighting effect may be provided based on a position and a sort corresponding to the identified object.

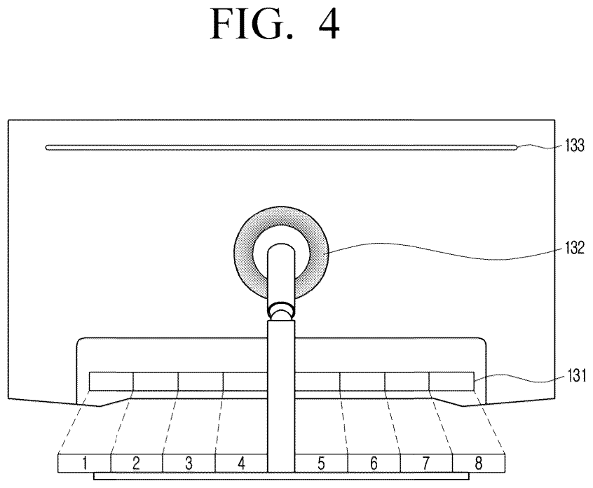

Specifically, the display apparatus 100 may be provided with a lighting device including a plurality of light emitting elements capable of emitting light in the lower end direction of the display apparatus, and in the case where an image is input, may sense a predefined object in the image. For convenience of description, the lighting device is described above under the assumption that the lighting device is disposed at the lower end of the display apparatus, but when implemented, the lighting device may emit light in another direction of the display apparatus as well as the lower end direction thereof. Examples in relation to this are described hereafter with reference to FIG. 4.

When sensing the predefined object, the display apparatus 100 may obtain position and color information corresponding to the object, and may control the lighting device to provide a lighting effect corresponding to the obtained information. The object may be referred to as a UI element, an object, an object of interest and the like.

For example, the display apparatus 100, as illustrated in FIG. 1, may identify the presence of an object 111 predicted as an enemy on a screen, and may provide lighting 20 to an area 21 corresponding to the position of the object.

As the display apparatus 100 provides lighting in response to the position of a specific object as described above, the user may be absorbed more deeply into a screen area corresponding to the position of the lighting, and even in the case where the user is focusing on another area, the user may be prevented from failing to identify the object.

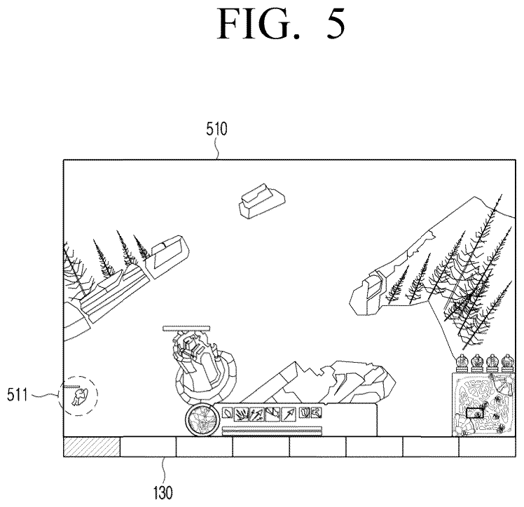

Meanwhile, the above-described object of interest may vary depending on the sort of a game (or a game genre). That is, in the illustrative example, it is assumed that the object of interest is a counter object, but the object of interest may differ in another sort of game and game genre. Operations based on various sorts of games are described hereafter with reference to FIGS. 5-9. Meanwhile, to identify an object of interest in response to various sorts of games or game genres, in the disclosure, an object recognition method (or a recognition module, an AI model) corresponding to the sort of a game may be used.

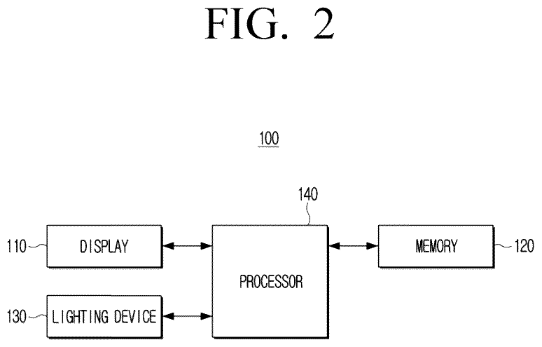

The display apparatus 100 may control a lighting device by using sound information as well as images. For example, in the case where the sound of steps of an object or a bullet moving from the left side to the right side is identified, the display apparatus 100 may display lighting corresponding to the position (or a moving direction) of the object. A specific configuration and operation of the display apparatus 100 are described hereafter with reference to FIG. 2.

The display apparatus 100, as described above, may provide lighting that makes it easy for the user to recognize main information during the process in which game contents proceed, rather than simply displaying main colors of a screen, leading to an increase in the immersion feeling toward the contents.

Meanwhile, in FIG. 1, applying the subject matter of the disclosure to game contents is illustrated and described, but when implemented, a lighting environment may be provided even in the case of contents except for game contents. For example, in the case where the user sees a movie by using the display apparatus 100, the display apparatus 100 may output lighting in response to the genre and situation of the movie. For example, in the case where an explosion scene is sensed in an action movie, the display apparatus 100 may output lighting corresponding to color information of the explosion scene.

Meanwhile, in FIG. 1, applying operations according to the disclosure to the display apparatus is illustrated and described, but when implemented, may also be applied to an electronic apparatus including no display. For example, an electronic apparatus may provide video to a micro LED or signage display and control a lighting device associated with the display. In this case, the lighting device may be attached to the display, or may be spaced from the display and disposed around the display.

Meanwhile, in FIG. 1, outputting lighting independently only by the display apparatus is illustrated and described, but may perform a lighting operation by interworking with another device. For example, in the illustrative example, the display apparatus may interwork with a keyboard, and emit light by interworking light of a plurality of areas of the keyboard with a plurality of areas of the above-described lighting device.

FIG. 2 is a block diagram illustrating a configuration of a display apparatus according to one embodiment.

Referring to FIG. 2, the display apparatus 100 includes a display 110, memory 120, a lighting device 130 and a processor 140.

The display 110 may be implemented as various types of displays such as a liquid crystal display (LCD), an organic light emitting diode (OLED) display, a plasma display panel (PDP), a micro LED and the like. In the display 110, driving circuitry implementable in the form of an a-si TFT, a low temperature poly silicon (LTPS) TFT, an organic TFT (OTFT) and the like, a backlight unit, and the like may be included together. Meanwhile, the display 110 may be implemented as a touch screen coupled with a touch sensor, a flexible display, a three-dimensional (3D) display, and the like.

The display 110 may display a screen corresponding to an image. Herein, the screen includes an image displayed on the display 110. The image may also be referred to as terms such as a frame and the like. On the screen, various types of objects such as an icon, a text, a picture, a moving image, a widget and the like may be displayed.

The image may be an image having fixed refresh frequency or an image having variable refresh frequency. If an input image has variable refresh frequency, the display 110 may operate at a refresh rate corresponding to refresh frequency of the input image.

Herein, the refresh frequency may denote a speed at which a display displays data of one screen, and may also be referred to as a frame rate, refresh frequency, a screen refresh rate, a frame speed, a frame rate or a refresh rate and the like. For example, frames per second may indicate the number of screens viewed for one second, and may use a unit of fps (or frame/second).

Accordingly, the fixed refresh frequency means that refresh frequency remains constant while an image is displayed, and variable refresh frequency means that refresh frequency is changed while an image is displayed.

The memory 120 may store instructions, programs or data for controlling the display apparatus 100. Herein, the instructions may include an instruction for sensing an object in an image, an instruction for controlling lighting based on position information and color information, an instruction for controlling the display by using an input image and the like.

For example, the memory 120 may be implemented as internal memory such as ROM (e.g., electrically erasable programmable read-only memory (EEPROM)), RAM and the like included in the processor 140, or memory separate from the processor 140. In this case, the memory 120 may be implemented in the form of memory embedded in the display apparatus 100, or in the form of memory detachable from the display apparatus 100 depending on a data storage purpose. For example, data for driving the display apparatus 100 may be stored in memory embedded in the display apparatus 100, and data for an extension function of the display apparatus 100 may be stored in memory detachable from the display apparatus 100. Meanwhile, the memory embedded in the display apparatus 100 may be implemented as at least one of volatile memory (e.g., dynamic RAM (DRAM), static RAM (SRAM) or synchronous dynamic RAM (SDRAM), and the like), or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash and the like), hard drive, or solid-state drive (SSD)), while the memory detachable from the display apparatus 100 may be implemented in the form of a memory card (e.g., compact flash (CF), secure digital (SD), micro secure digital (Micro-SD), mini secure digital (Mini-SD), extreme digital (xD), a multi-media card (MMC) and the like), external memory (e.g., USB memory) connectable to a USB port, and the like.

The memory 120 may temporarily store an image obtained through an input/output interface 170 described hereafter, or store contents corresponding to an image. The memory 120 may store various types of contents (e.g., broadcast contents, applications and the like) received through a communicator 160 described hereafter.

Meanwhile, in the illustrative example, the display apparatus 100 is comprised of one memory, but in the case where volatile memory and non-volatile memory are referred to in a differentiated manner, the display apparatus 100 may also be referred to as including a plurality of memories.

The memory 120 may store a learning model for identifying a plurality of objects. Herein, the learning model may be referred to as an AI model, an object identification algorithm and the like. In the case where an image is input, the learning model may be a model finding whether a specific object is included in the input image.

Herein, the specific object sensed may vary depending on a training method. Accordingly, when implemented, a learning model learns objects used in various types of games in an integrated manner, or differentiates and learns objects based on each game genre, such that at a time of use, a learning model appropriate for a game genre may be used.

Such a learning model may perform object recognition. The object recognition includes identifying an object from an image. For example, the object recognition may include analyzing visual information in an image and categorizing an object based on the sort thereof. The object may include all objects differentiated from a background in an image. Depending on embodiments, processes of finding whether an object is present in an image and finding the position of the object may be included in the object recognition.

Herein, the object may be characters or items in contents. The items include graphic elements displayed on a display. The items may include a graphic element providing information to the user, or being capable of interacting with the user based on a user input of selecting or executing an item. For example, the items may be referred to as an object, a UI element, a UI object and the like, and may include icons, buttons, images and the like.

Different sorts of learning models may be used depending on the genres of contents, and a different learning model may be used for each sort of contents. When implemented, such learning models may also be applied to a different type of contents such as a movie as well as game contents.

The lighting device 130 includes a plurality of light emitting elements capable of emitting light in the lower end direction of the display apparatus. For example, the lighting device 130 may divide the lower end area of the display apparatus into a plurality of areas, and may provide individual lighting to each divided area.

As for the lighting device 130, the plurality of light emitting elements may be spaced from each other in the lower end area of the display. Herein, each light emitting element may be comprised of one element or a plurality of elements. For example, in response to one area, an R LED emitting red light, a G LED emitting green light, and a B LED emitting blue light may be included. A specific way of disposing the lighting device is described hereafter with reference to FIG. 4.

The lighting device may provide individual lighting to the plurality of areas as described above, such that the user may intuitively know an area to which the user needs to give attention on a display screen.

The processor 140 controls entire operations of the display apparatus 100. Specifically, the processor 140 may be connected with an element of an electronic apparatus including a display 110, memory 120 and a lighting device 130, and by executing at least one instruction stored in the above-described memory 120, may control entire operations of the electronic apparatus. In particular, the processor 140 may be implemented by a plurality of processors 140 as well as one processor 140.

The processor 140 may be implemented as one or more integrated circuit (or circuitry) chips, and execute various types of data processing. The processor 140 may include at least one electrical circuit, and perform distribution processing of instructions (or programs, data and the like) stored in the memory individually or collectively.

The processor 140 may include a processor set including one or more processing circuits. The processor 140 may include any processing circuit operative to control performance and operations of one or more elements (e.g., memory and/or a driving device (a sensor)) of an electronic apparatus. For example, the processor 140 (e.g., AP) may be implemented as a system on a chip (SoC; e.g., one chip or one chip set). For example, the processor 140 may be implemented as a plurality of cores (or at least one core circuit), a plurality of chips or a plurality of chip sets.

For example, the processor 140 may include one or more processing circuits. The processor 140 may include one or more processing circuits configured to perform various functions of the disclosure individually and/or collectively. As a non-limited example, at least part of the processor 140 may be included in a first chip of the display apparatus 100, and at least the other part of the processor 140 may be included in a second chip of an electronic apparatus, which is different from the first chip of the display apparatus 100.

For example, the processor 140 may include a central processing unit (CPU), a graphics processing unit (GPU), a neural processing unit (NPU), an image signal processor (ISP), a display controller, a memory controller, a storage controller, a communication processor (CP) and/or a sensor interface. The above-described elements of the processor 140 are described merely as examples. The processor 140 may further include other elements in addition to the above-described elements. Some of the elements of the processor 140 may be omitted. Further, some of the elements of the processor 140 may be included as a separate clement of the display apparatus 100 outside the processor 140. For example, part (e.g., a memory controller) of the elements of the processor 140 may be included in other elements (e.g., at least part of memory, an interface (e.g., used to connect to at least one element of the display apparatus 100), a display).

The processor 140 may cause the other elements of the display apparatus 100 to perform various operations by executing the instructions stored in the memory.

The processor 140 may process a set value, a function instruction and the like based on a pre-stored control program or control data, and may output a control signal in association with functions performable by the electronic apparatus or a communication signal for communicating with an external electronic apparatus.

In the case where an image is obtained, the processor 140 may control the display 110 to display a screen corresponding to the image.

The processor 140 may control the lighting device by using the obtained image. For example, when sensing a predefined object in the image, the processor 140 may obtain position information and color information corresponding to the sensed object.

For example, the processor 140 may divide the image into a plurality of areas, may input, to a learning model, an area where there is a change in the screen among the plurality of divided areas, and may identify whether the predefined object is present in the area. In the case where there is the predefined object, the learning model may output position information of the object and the sort thereof.

Herein, the position information may be used to select an area where a lighting effect described hereafter is to be provided, and the sort of the object may be used to select a size and a color of the area. For example, since an object in game contents may have various sizes and effects, in the case of an object having a small size, one of the plurality of areas may only indicate that there is the object, while in the case of an object having a large size, several areas may be used to indicate that there is the object.

A color to be displayed may be determined based on the sort of the identified object. For example, it may be determined that a color of low saturation is used for an object of a low danger level, and a color of high saturation is used for an object of a high danger level. In a specific game, a specific color may be given to each team or each user. Further, in the case where various users proceed with a game together while a user of a currently sensed object determines yellow as a color for a team, the processor 140 may determine yellow as a color of the object.

As described above, various objects may affect a lighting effect, and objects may vary depending on a manipulation method of a game. Since such a manipulation method may be similar based on each genre of a game, a similar object recognition or lighting provision method may be used for an identical genre according to the disclosure. Herein, the genre may be a standard for grouping items of similar subjects or development methods and the like in a specific field, and may be referred to as a category, a classification, a style and the like.

Meanwhile, the above-describe method is described merely as an example, and even in the case of an identical genre, a different algorithm or a different method may be used. In this case, when identifying the sort of a game, the processor 140 may obtain an algorithm (or an object recognition learning model) corresponding to the sort of the identified game from an external server, for use.

When obtaining color information to be used for the position and lighting of a predefined object based on the above-described method, the processor 140 may control the lighting device such that a light emitting element corresponding to the obtained positon among the plurality of light emitting elements may output a specific color.

The processor 140 may determine a color and a brightness level (or luminance) in which each of the plurality of light emitting elements operates, and may generate control information on each light emitting element and provide the control information to the lighting device such that each light emitting element operates in the determined color and at the determined luminance. For example, the control information may be provided to the lighting device based on I2C.

Herein, the attributes of the color may be divided into a hue, brightness and saturation. For example, the hue may include the name of a color. The brightness may include a brightness level and a darkness level of a color. The saturation may include a level indicating how vivid a color appears.

A tone may include a combination of brightness and saturation. For example, a high tone relates to high brightness and high saturation and involves bright, vivid colors, while a low tone relates to low brightness and low saturation and involves dark, cloudy colors.

As one example, a color gamut (or a color area, a color reproduction rate) may include a level at which the colors of an image can be reproduced on a screen output by the display, and a range of colors that can be displayed by the display. For example, the color gamut may be displayed at a percentage based on a color standard such as NTSC, sRGB, Adobe RGB, DCI-P3 and the like in the CIE color coordinate system.

A contrast (or, a contrast ratio) according to one example may denote a difference between the brightest area and the darkest area in an image output by the display. For example, the contrast may include a value representing, as a numerical value, a difference between maximum luminance (e.g., white) and minimum luminance (e.g., black) of the display.

Meanwhile, in the case of a lighting device capable of outputting lighting to another area as well as the lower end area of the display apparatus, the processor 140 may perform control of the lighting output to another area. For example, the processor 140 may obtain RGB gradation data in a preset-area of an image and control the lighting device to emit light corresponding to the RGB gradation data.

When identifying an object, the processor 140 may store information on the object in the memory 120. The processor 140 may update the stored information on the object by monitoring the object continuously. For example, in the case where a counterpart unit is seen and then is hidden in the forest and is not seen, that is, the counterpart unit is not displayed by overlapping another object, the user may not recognize the object. Even in this case, the processor 140 may provide information on the hidden object in the form of position information and a color.

Meanwhile, when obtaining acoustic data, the processor 140 may sense a pre-set sound in the obtained acoustic data, and based on the sensed sound, may generate control information. For example, when obtaining steps approaching from the left side, the processor 140 may output lighting to the left side, which is recognizable by the user. Alternatively, the processor 140 may control the lighting device 130 to output a color corresponding to the sort of the identified sound.

Meanwhile, the processor 140 may control lower end lighting of the display apparatus, generally considering the information of an image and sound described above. For example, in the case where an area to be displayed by an image, and an area to be displayed by information of a sound differ from each other, the processor 140 may only display any one of the information of an image and information of a sound based on a priority. To this end, an individual priority may have been given to each object, and a priority may also have been given to a voice based on each sort of a sound.

Meanwhile, when implemented, each area may all be displayed individually. For example, the processor 140 may control lighting based on the information of an image in the lower end area of the display apparatus, while controlling lighting based on the information of a sound in another area of the display apparatus.

The control method described above according to the disclosure may allow the user to be deeply absorbed in a game through lighting interworking with contents of the display apparatus. A change in the state of an object in an image may be notified to the user based on lighting, such that the user may obtain additional information based on the lighting.

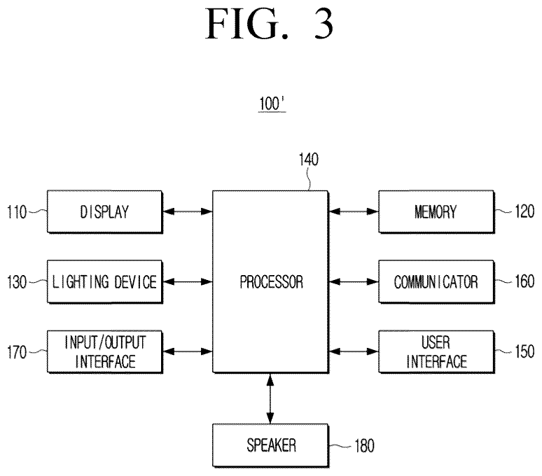

Meanwhile, simple elements constituting the display apparatus 100 are only illustrated and described above, but when implemented, various elements may be provided additionally. Description in relation this is provided hereafter with reference to FIG. 3.

FIG. 3 is a block diagram illustrating a configuration of a display apparatus according to one embodiment.

Referring to FIG. 3, a display apparatus 100′ may include a display 110, memory 120, a lighting device 130, a processor 140, a user interface 150, a communicator 160, an input/output interface 170 and a speaker 180.

The configurations of the display 110, the memory 120, the lighting device 130 and the processor 140 are described above with reference to FIG. 2, and accordingly, operations different from those in FIG. 2 are only described hereafter.

The user interface 150 is an element interfering with an interaction of the display apparatus 100 with the user. For example, the user interface 150 may include at least one of a touch sensor, a motion sensor, a button, a jog dial, a switch or a microphone, but not be limited thereto. Meanwhile, when implemented, a control instruction may be input through a remote control device (or a remote controller) rather than the user interface 150.

The user interface 150 may receive a selection of information on a game genre (or the sort of a game). Herein, the information on the game genre may include the type of game contents provided through the display apparatus 100 or information on an area of interest corresponding to the type of the game contents, but not be limited thereto.

The user interface 150 may also receive an input of setting information for operations of the lighting device. For example, the user interface 150 may receive an input of color information corresponding to a specific object. The user interface 150 may also receive a setting whether to change lighting corresponding to an image according to the disclosure.

The communicator 160 is an element performing communication with various types of external devices based on various communication methods. The communicator 160 may include a Wi-Fi module, a Bluetooth module, an infrared communication module and a wireless communication module and the like. Herein, each communication module may include at least one hardware chip or hardware circuit.

The Wi-Fi module and the Bluetooth module may perform communication respectively based on a Wi-Fi method and a Bluetooth method. In the case where the Wi-Fi module or the Bluetooth module is used, various types of connection information such as an SSID, a session key and the like may be first transmitted and received, and are used to perform communication connection and then transmit and receive various types of information.

The infrared communication module performs communication based on an infrared Data Association (IrDA) communication technology which transmits data wirelessly over a short distance using infrared rays between visible light and millimeter waves. For example, the communicator 160 may also receive various types of settings (e.g., a game genre and the like) in the above-described display apparatus 100 from a remote control device based on the IrDA communication and the like.

In addition to the above-described communication methods, the wireless communication module may include at least one communication chip that performs communication according to various wireless communication standards such as Zigbee, 3rd Generation (3G), 3rd Generation Partnership Project (3GPP), Long Term Evolution (LTE), LTE Advanced (LTE-A), 4th Generation (4G), 5th Generation (5G) and the like.

In addition, the communicator 160 may include at least one of wired communication modules that perform communication by using a local area network (LAN) module, an Ethernet module, pair cables, coaxial cables, fiber optic cables, or an Ultra Wide-Band (UWB) module and the like.

As one example, the communicator 160 may use an identical communication module (e.g., a Wi-Fi module) to perform communication with an external device such as a remote controller and an external server.

In another example, the communicator 160 may use a different communication module (e.g., a Wi-Fi module) to perform communication with an external device such as a remote controller and an external server. For example, the communicator 160 may use at least one of the Ethernet module or the Wi-Fi module to perform communication with an external server, or may use a BT module to perform communication with an external device such a remote controller. However, this is described merely as an example, and the communicator 160 may use at least one of various types of communication modules in the case where the communicator 160 performs communication with a plurality of external devices or external servers.

The communicator 160 may receive contents. The contents may include various types of contents such as movies, music videos, dramas, shorts and the like. It may be assumed that the contents are moving images, but the contents may also be referred to as images or moving images.

The communicator 160 may receive various types of applications of the display apparatus 100 and information required to provide services and the like as well as contents from an external device. For example, the communicator 160 may also receive a learning model corresponding to a game genre (or the sort of a game).

The input/output interface 170 may be an interface of any one of a High-Definition Multimedia Interface (HDMI), a Mobile High-Definition Link (MHL), Universal Serial Bus (USB), Display Port (DP), Thunderbolt, a Video Graphics Array (VGA) port, an RGB port, D-subminiature (D-SUB), a Digital Visual Interface (DVI).

The input/output interface 170 may input and output at least one of an audio signal and a video signal. Depending on embodiments, the input/output interface 170 may separately include a port inputting and outputting an audio signal only, and a port inputting and outputting a video signal only, or may be implemented as one port inputting and outputting both the audio signal and the video signal.

The input/output interface 170 may provide, to an external device (e.g., a display apparatus, an STB and the like), a video signal corresponding to a screen generated by an electronic apparatus 100′ or an audio signal together with the video signal. Meanwhile, when implemented, an image and a sound may be received through a HDMI terminal, and the received image may be displayed on the display 110 while the sound may be output through a speaker of another external device.

The speaker 180 may output a sound. Specifically, the speaker 180 may be an element that outputs various types of notification sounds or voice messages and the like as well as various types of audio data processed in the input/output interface. The speaker 180 may also output result information corresponding to a voice recognition operation described hereafter.

The speaker 180 is a device converting, into soundwaves, an electroacoustic signal that is generated from the processor 140 and corresponds to an audio provided by the display apparatus 100. The speaker 180 may include a permanent magnet, a coil and a diaphragm, and may output a sound by vibrating the diaphragm based on an electromagnetic interaction occurring between the permanent magnet and the coil. For example, the processor 140 may control the speaker 180 to output an audio corresponding a game image provided through the display 110.

Meanwhile, in FIG. 3, the display apparatus 100 including a display 110 is illustrated and described above, but in the case where the electronic apparatus 100′ is a device such as a set-top box including no display, the display element may be omitted. Depending on the implementation, the above-described speaker and microphone may also be omitted from the display device. Further, though not illustrated in FIG. 3, another element (e.g., a camera) and the like may be further included in the electronic apparatus.

FIG. 4 is a view provided to explain various light emitting positions according to the disclosure.

Referring to FIG. 4, the lighting device 130 includes a plurality of light emitting areas 131, 132, 133.

A first light emitting area 131 is an area that is divided in the way that the lower end area of the display apparatus 100 is divided into a plurality of areas and emits light. For example, in the case where a predefined object is sensed, the first light emitting area 131 may output light to an area corresponding to the position of the sensed object. For example, in the case where a screen is divided into eight areas, based on sensing a specific object in a fifth area, a light emitting element corresponding to a fifth column (row) in the first light emitting area 131 may emit light. The first light emitting area may be referred as lower end lighting.

In the illustrative example, the first light emitting area 131 is disposed on the rear surface of the display apparatus and emits light in the lower end direction of the display apparatus, but when implemented, the first light emitting area may be disposed at the lower end of the display apparatus 100 and may operate.

In the illustrative example, the lower end area is divided into eight areas for use, but when implemented, the lower end area may be divided into the above-described number or greater of areas, or the above-described number or less of areas.

Meanwhile, when implemented, one area or a plurality of areas may emit light per one object. In a racing game, a screen may be divided into three areas such as a right area, a left area and a central area, for use. That is, in the illustrative example, the screen divided into eight areas for use is illustrated and described, but when implemented, the screen may be divided into smaller areas for use, or may be segmented further for use. The number of such areas may be divided based on the size of the screen of a display apparatus or the sort of a game and the like.

A second light emitting area 132 is an area that emits light from the center of the display toward the rear surface thereof. The second light emitting area may emit light in response to a specific event such as a start or an end and the like of a game. The second light emitting area may be referred to as sub lighting.

A third light emitting area 133 is an area that emits light from the upper end area of the display toward the rear surface thereof. Like the second area, the third light emitting area 133 may perform a light emitting operation at a time when a game starts to proceed or ends, or may display a main color of the screen. The third light emitting area may be referred to as rear surface lighting.

Furthermore, when implemented, lighting of the first light emitting area 131 may be controlled in response to the images of contents, while lighting of the third light emitting area 133 may be controlled in response to the sounds of contents.

Since light in association with a screen is output in various directions of the display apparatus as described above, the screen in the display apparatus and a space surrounding the display apparatus may have light in association with game contents, that is, game contents may be provided to a surrounding space as well as a screen in an expanded manner, enhancing an immersion feeling of the user.

The lighting device disposed only on the rear surface of the display apparatus is illustrated in FIG. 4 and described with reference to FIG. 4, but when implemented, the lighting device may be disposed on the lateral surface, the upper surface and the like of the display apparatus.

For example, a fourth light emitting area divided into a plurality of areas may be disposed at the upper end of the display apparatus, and emit light in the upper end direction. In this case, the position of an object on a screen is determined based on a column to be divided into two rows rather than being determined merely based on a column. In the case where a predefined object is sensed in the lower end area of the screen, the first light emitting area 131 may be used, and in the case where a predefined object is sensed in the upper end area of the screen, the fourth light emitting area may be used. The above-described operation may also mean that a light emitting area closest to each object of the screen among the plurality of light emitting areas of the display emits light.

FIG. 5 is a view provided to explain an operation example of a lighting device according to one embodiment. Specifically, FIG. 5 shows an example for explaining an operation of the display apparatus 100 in the case where a screen corresponding to a multiplayer online battle arena (hereafter, MOBA) contents is displayed.

Referring to FIG. 5, the MOBA genre includes games where an object of a person or an object of a counterpart proceed with an attack or a defense on a map while moving. In the above-described MOBA genre, since a screen displays partial areas constituting the map, an object of the counterpart may come in from an outer area. The user needs to identify and cope with such a new object to win the game.

In this context, the display apparatus 100 may sense a counterpart game unit 511. For example, as illustrated in FIG. 5, in the case where the game unit 511 is sensed in the left area, lighting of the left area in the lighting device may be output. At this time, based on the size of the game unit and the like, lighting in one area may only be output or lighting in a plurality of areas may be output. Meanwhile, when implemented, based on an attack range (or a speed) of the unit, a lighting area (or a lighting range) may also be determined regardless the size of the unit.

Based on a danger level of a corresponding object and the like, a color of low saturation or a color of high saturation may be used. For example, in the case where a sensed object has high aggressiveness, a color of high saturation may be used, while in the case where a sensed object has low aggressiveness, a color of low saturation may be used.

Meanwhile, in the illustrative example, an example of merely sensing a counterpart unit is illustrated, but in the case where a counterpart unit and a user unit fight with each other, lighting may be output only in the area where a corresponding attack or defense proceeds. Accordingly, the user may remain immersed in the area where the attack or defense proceeds.

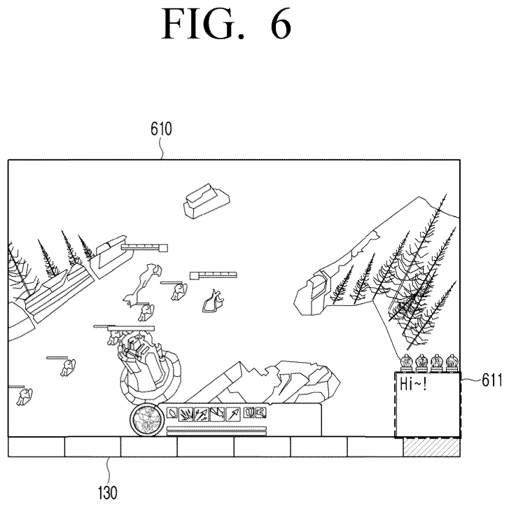

FIG. 6 is a view provided to explain an operation example of a lighting device according to one embodiment.

Referring to FIG. 6, the display apparatus 100 outputs a game screen 610. A message area 611 may be provided at the lower end of the right side of the game screen. In the case where a new alarm or message is generated in the message area, the display apparatus 100 may turn on lower end lighting of the message area 611 such that the user may see the message.

Meanwhile, since the message area is an additional portion of a game, an additional lighting displaying operation may not proceed during an attack or a defense at a specific positon, despite an input of a new text to the message area.

Meanwhile, turning on lighting depending on whether a message is displayed is illustrated and described above, but when implemented, lighting may be provided to a corresponding area even in the case where a message is displayed and a sound such as a message notification is sensed.

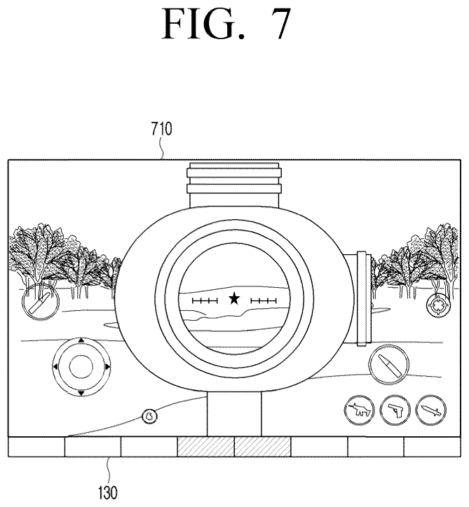

FIG. 7 is a view provided to explain an operation example of a lighting device according to one embodiment. Specifically, FIG. 7 shows an example of an operation of the display apparatus 100 in the case where a screen corresponding to a first-person shooting game (a first-person shooter or hereafter, FPS) contents is displayed.

Referring to FIG. 7, a counterpart (or a counterpart unit) may be detected on a screen. For example, in the case where the counterpart unit has a star shape, the display apparatus may sense the start shape in an image. For example, based on sensing an object, an object recognition model may provide position information (i.e., (Xn) section in the x-axis direction, (Yn) section in the y-axis direction, a total number of (Xn×Yn) sections) of the image used to sense the object to the lighting device.

The lighting device 130 may perform a lighting operation based on the x-axis information out of the provided position information. At this time, based on an attack from the counterpart, the lighting device 130 may differentiate a color of lighting displayed in response to a weapon for attack used by the counterpart. Such a weapon may be differentiated based on analysis of an image or analysis of a sound (e.g., a gun sound, an arrow sound and the like). The lighting device 130 may display a color corresponding to the sort of an identified weapon.

For example, the gun sound may be displayed as red, while the arrow sound may be displayed as orange. Based on identifying a gun and an arrow, light may be emitted in one cubicle, while based on identifying that a weapon such as the cannon of a tank and the like having a wide attack range is being used, light may be emitted in the plurality of areas. Meanwhile, such a display area may correspond to the size of an area affected by an attack of the counterpart.

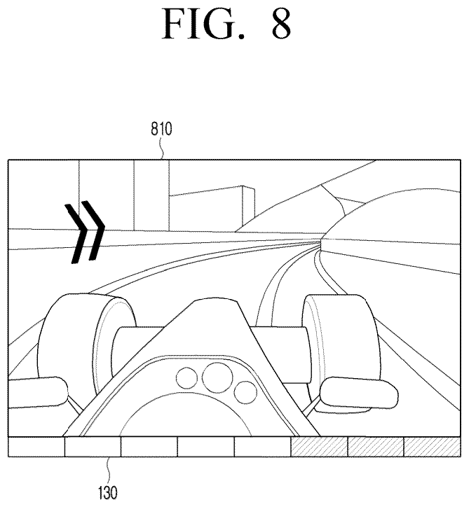

FIG. 8 is a view provided to explain an operation example of a lighting device according to one embodiment. Specifically, FIG. 8 shows an example for explaining an operation of the display apparatus 100 in the case where a screen corresponding to racing contents is displayed.

Referring to FIG. 8, a user interface window 810 may display a screen including a racing track. At this time, the display apparatus 100 may obtain information corresponding to a signpost in the screen, and output lighting corresponding to the obtained signpost.

For example, in the case of a right turn as illustrated, the right area of the lighting may be used, while in the case of a left turn, the left area of the lighting may be used.

Meanwhile, the determination and display of the lighting area based on a road situation (or a signpost) are described above, but when implemented, the lighting area may be displayed in response to a handle direction of a vehicle object. That is, lighting corresponding to a manipulation operation of the user may be output, such that the lighting may be provided based on whether the user currently manipulates a right turn or a left turn. When implemented, control information enabling a vehicle to be disposed at the center of a road may be provided as lighting information.

The lighting device 130 may output lighting in response to a speed regardless of a handle steering or a signpost, and change the color of lighting and output the lighting based on a speed and the like. For example, in the case where a vehicle is being driven on a road with a sharp curve, red lighting may be output at a speed greater than or equal to 100 km, orange lighting may be output at a speed between 50-100 km, and yellow lighting may be output at a speed less than or equal to 50 km.

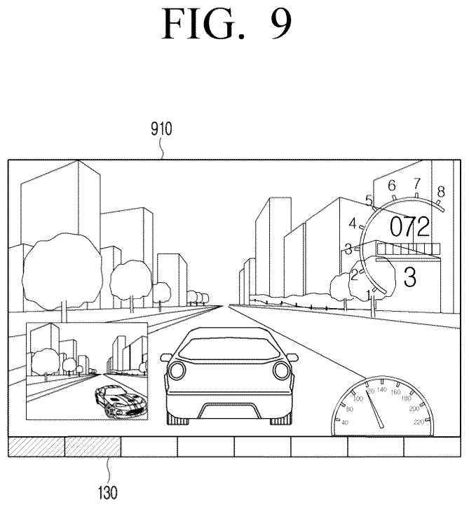

FIG. 9 is a view provided to explain an operation example of a lighting device according to one embodiment.

Referring to FIG. 9, a user interface window 910 may display a screen including a racing track. Herein, an object of interest may be a vehicle behind an object (a vehicle) of the user. In the case where the display apparatus identifies a counterpart vehicle on the left side of the rear of the vehicle of the user, lighting may be output to the left side of the screen. In this case, the user may easily recognize the vehicle in the left area of the rear of the vehicle of the user.

At this time, the display apparatus may analyze a sound to identify whether the vehicle behind the vehicle of the user approaches or moves away, and based on the sound, may display lighting of a different color.

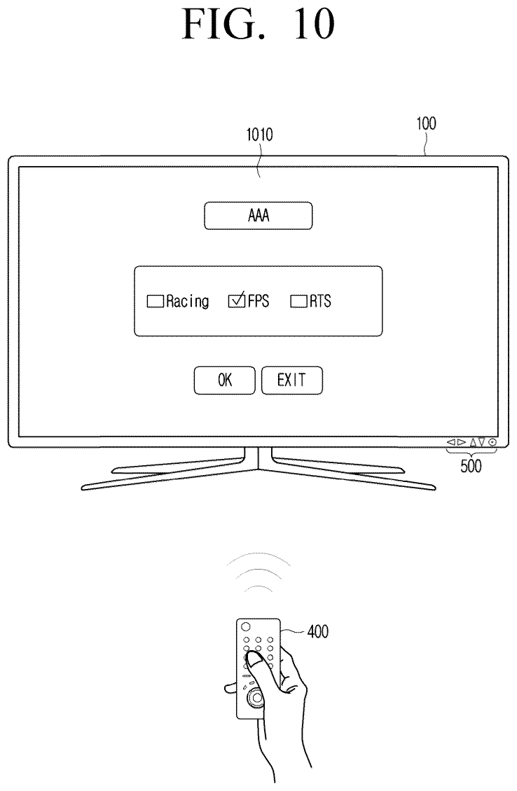

FIG. 10 is a view illustrating an example of a user interface window for receiving a setting of a game genre according to one embodiment.

Referring to FIG. 10, the display apparatus 100 may display a user interface window 1010 for receiving a selection of a game genre.

For example, in the case where the display apparatus differentiates three different game genres, the display apparatus may display the user interface window 1010 for receiving a selection of one of the three genres. Meanwhile, in the illustrated example, three genres of games are illustrated under the assumption that the display apparatus differentiates three genres of games, but when implemented, genres of games may be divided more specifically. When implemented, the user interface window may receive a selection of a game itself rather than a genre.

Meanwhile, in the case where the above-described user interface window 1010 is displayed, the user may select one item to be used among a plurality of displayed items. Such a selection may proceed by using a remote control device 400 or through a button provided at the display apparatus 100, as illustrated.

The remote control device 400, as illustrated in FIG. 4, may be implemented as a remote controller controlling a display apparatus 100, but this may be described merely as one embodiment, and may also be implemented as various types of mobile terminals such as a smart phone, a tablet PC and the like.

In the case where the remote control device 400 is used, the display apparatus 100 may further include an RF signal module for receiving a remote controller signal generated by the remote control device 400. Alternatively, in the case where the remote control device 400 and the display apparatus 100 are connected based on a wireless communication method such as Bluetooth communication and the like, the processor 140 may receive a control signal of the remote control device 400 through the communicator 160.

Meanwhile, in FIG. 10, the above-described user interface window displayed in the entire area of the screen is illustrated, but when implemented, the user interface window may also be displayed together with an image corresponding to game contents.

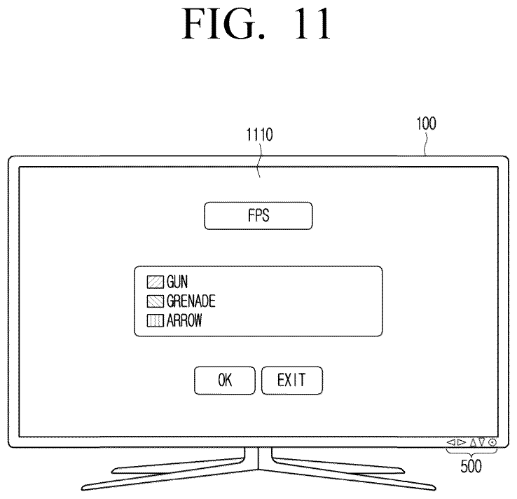

FIG. 11 is a view illustrating an example of a user interface window for receiving a setting of color information according to one embodiment.

Referring to FIG. 11, the display apparatus 100 may display a user interface window 1110 for receiving an input of color information of a specific object. For example, the user interface window 1110 is a user interface window that may be displayed additionally in the case where the user selects an FPS game in FIG. 10.

Through the above-described user interface window 1110, a setting of a color of each object may be received. Meanwhile, in FIG. 11, a color in association with guns is only illustrated, but when implemented, the user interface window may receive an input of a color of a counterpart tribe and the like. Meanwhile, in the illustrative example, the user sets a color directly, but when implemented, color information on each object may be obtained through a manufacturer and stored in the display apparatus 100.

For example, under the assumption that the user sets a gun to a red color, while setting a grenade to a blue color, in the case where a gun sound is generated, red lighting may be provided in an area corresponding to a source area corresponding to the gun sound.

In the case where a sound caused by an explosion of a grenade is generated, blue lighting may be displayed in a rea corresponding to a source area. Meanwhile, based on identifying that the grenade is exploded in a somewhat distant area rather than a nearby area, lighting at the lower end of the display apparatus may not operate, while lighting in the rear surface direction of the display may only be displayed in blue.

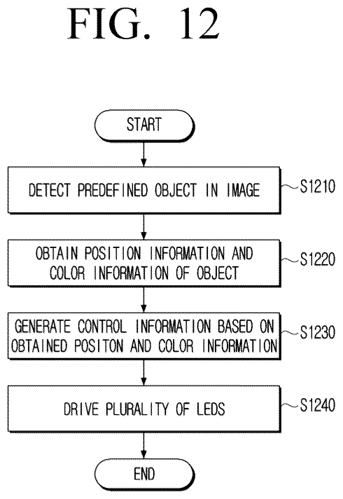

FIG. 12 is a flowchart provided to explain a control method of a display apparatus according to one embodiment.

Referring to FIG. 12, a predefined object is sensed in an image (S1210). To this end, the control method may include pre-storing information on an object of interest based on each game type, obtaining a game type corresponding to the image, and sensing whether an object of interest corresponding to the obtained game type is present in the image. For example, a previous frame and a current frame may be compared to sense whether an object is present in an area where the image is highly changed.

The game type may be determined based on a layout of an image, and may also be selected by the user through the user interface window.

The control method includes obtaining position information and color information corresponding to the sensed object (S1220). For example, the image may be divided into a plurality of areas, and it may be sensed whether the predefined object is present in each divided area, such that the area to which the sensed object belongs may be used as position information. Color information corresponding to the object may be obtained. The color information may be a color value that is pre-determined by the user based on each object sort, and in a specific game type, a main color of a game screen or a color of a specific area of a game screen may also be used.

Control information may be generated such that at least one light emitting element corresponding to the position information among a plurality of light emitting elements capable of emitting light in the lower end direction of the display apparatus may emit light of a corresponding color (S1230). For example, the control information may be generated such that a moving direction of the sensed object may be obtained and a light emitting element belonging to the lower end area corresponding to the obtained moving direction may emit light.

In the case where acoustic data are obtained, a predefined sound may be sensed in the obtained acoustic data, and control information may be generated based on the sensed sound.

Furthermore, the generated control information may be provided to the lighting device, or the lighting device may be directly controlled to emit light (S1240).

The control method according to the disclosure may enable the user to be deeply absorbed in a game play through lighting interworking with contents of the display apparatus, as described above.

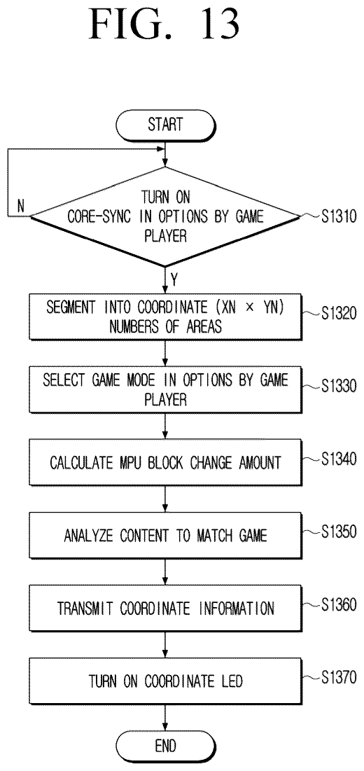

FIG. 13 is a flowchart provided to explain a lighting control method according to one embodiment.

Referring to FIG. 13, the user may set whether to perform operations according to the disclosure (S1310). The operations according to the disclosure may be referred to as a core-sync, and may also be referred to as a 3rd generation arena effect, a lighting effect and the like.

In the case where the user sets to perform the operations according to the disclosure, a screen may be divided into a plurality of areas (S1320), and an individual operation may be performed based on each divided area. Object sensing may be performed based on each area, with an algorithm corresponding to a game type selected by the user.

For example, the user may select a game type by using an OSD. In the case where the game type is selected as described above, an AI algorithm corresponding to the game type may be used (S1330). Meanwhile, when implemented, a game type may be automatically identified and used based on recognizing an object and sensing a layout and the like.

Specifically, a change amount of an image may be identified in each area (S1340), and an object of interest may be identified by using an algorithm suitable for each game type in an area of which the change amount is at a certain level or above (S1350). For example, if an RTS game type is being used, it may be determined whether the brightness of screen analysis histogram is changed severely, or a counterpart object (or a specific event) is present in an area brighter than surroundings.

In the case where the object corresponding to the game type is identified as described above, coordinate information on the area and color information corresponding to the identified object may be provided to the lighting device (S1360).

In the case where the position information and the color information are input to the lighting device as described above, light emitting elements corresponding to a plurality of pieces of position information may emit light of a color corresponding to the color information (S1370). Meanwhile, operating only light emitting elements corresponding to the position information is described above, but when implemented, light emitting elements corresponding to the position information may operate in the way that the light emitting elements are highlighted, while the plurality of light emitting elements operate. That is, any method may be possible as long as the user can intuitively identify a specific area on a screen based on the operation of lighting.

As described above, the control method according to the disclosure may enhance an immersion feeling of a game player through lighting interworking with contents of the display apparatus, and additional information may be obtained through the lighting to increase a probability that the game player wins a game.

Meanwhile, the methods according to at least part of the above-described embodiments of the disclosure may be implemented in the form of an application that is installable in an existing electronic apparatus.

The methods according to at least part of the above-described embodiments of the disclosure may be implemented merely by upgrading software or hardware of an existing electronic apparatus.

The methods according to at least part of the above-described embodiments of the disclosure may be performed through an embedded server provided in an electronic apparatus, or an external server of at least one of electronic apparatuses.

Meanwhile, the embodiments described above may be implemented with software including instructions stored in a storage medium readable by a machine (e.g., a computer). The machine, as a device capable of calling the stored instructions from the storage medium and operating according to the called instructions, may include the electronic apparatus (e.g., electronic apparatus A) according to the disclosed embodiments. Based on instructions executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the “non-transitory storage medium” only means a tangible device and means including no signal (e.g., electromagnetic waves), while the term does differentiate semi-permanent or temporary storage of data in the storage medium. For example, the “non-transitory storage medium” may include a buffer where data are temporarily stored. According to one embodiment, the methods according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed (e.g., downloaded or uploaded) online through an application store (e.g., Play Store™) or directly between two user devices (e.g., terminal devices). In the case of online distribution, at least part of the computer program product (e.g., a downloadable app) may be stored at least temporarily, or generated temporarily in a machine-readable storage medium such as a server of a manufacturer, a server of an application store, or memory of a relay server.

The embodiments set forth herein may be implemented with software including instructions stored in a storage medium readable by a machine (e.g., a computer). The machine, as a device capable of calling the stored instructions from the storage media and operating according to the called instructions, may include the electronic apparatus (e.g., a display apparatus 100) according to the disclosed embodiments.

Based on the above-described instructions executed by a processor, the processor may perform functions corresponding to the instructions directly or by using other elements under the control of the processor. The instructions may include a code generated or executed by a compiler or an interpreter.

While the example embodiments of the disclosure are illustrated and described above, embodiments of the disclosure are not limited to the embodiments set forth herein, and certainly, various modifications thereof may be made by those skilled in the art to which the disclosure pertains, without departing from the scope the disclosure claimed in the section of claims, and are not to be understood as separating from the technical spirit or prospect of the disclosure.

1. A display apparatus comprising:
a display;
a lighting device including a plurality of light emitting elements configured to emit light from a lower end of the display apparatus;
a memory configured to store at least one instruction; and
one or more processors configured to execute the at least one instruction to:
control the display to display an image input to the one or more processors,
sense an object in the displayed image,
obtain position information and color information corresponding to the sensed object, and
control the lighting device so that at least one light emitting element, among the plurality of light emitting elements, that is at a location of the lower end of the display apparatus that corresponds to the obtained position information emits light of a color corresponding to the obtained color information.

2. The display apparatus of claim 1, wherein
the memory is further configured to store information about an object of interest respectively corresponding to each game type among a plurality of game types, and
the one or more processors are further configured to:
obtain a game type corresponding to the displayed image, and
determine whether the sensed object corresponds to the stored information about the object of interest of the obtained game type.

3. The display apparatus of claim 2, wherein
the information about the object of interest includes:
shape information of the object of interest, and
color information of an object of interest, and the one or more processors are further configured to:
based on a determination that the sensed object corresponds to the stored information about the object of interest, obtain color information about the sensed object.

4. The display apparatus of claim 2, further comprising:
a user interface configured to receive a selection of the game type corresponding to displayed image.

5. The display apparatus of claim 1, wherein
the one or more processors are further configured to:
divide the displayed image into a plurality of areas,
identify whether the sensed object is present in one or more areas among the plurality of areas, and
based on an identification that the sensed object is in the one or more areas, obtain position information corresponding to the one or more areas as the obtained position information.

6. The display apparatus of claim 5, wherein
the one or more processors are further configured to:
compare a previous frame of the displayed image and a current frame of the displayed image to determine an area of the displayed image where the displayed image has changed between the previous frame and the current frame, and
determine whether the sensed object is present in the area of the displayed image where the displayed image has changed.

7. The display apparatus of claim 5, wherein
the one or more processors are further configured to:
input the divided image to a learning model configured to identify an object, and
based on an output of the learning model indicating that the sensed object is present, identify a presence of the sensed object.

8. The display apparatus of claim 7, wherein
the memory is further configured to store a plurality of learning models respectively corresponding to each game type among a plurality of game types, and
the one or more processors is further configured to:
obtain a game type corresponding to the displayed image, and
perform object recognition with a learning model among the plurality of learning models that corresponds to the obtained game type.

9. The display apparatus of claim 1, wherein
the one or more processors is further configured to:
identify a moving direction of the sensed object, and
control the lighting device so that a light emitting element, among the plurality of light emitting elements, that is at a location of the lower end of the display apparatus that corresponds to the identified moving direction emits light.

10. The display apparatus of claim 1, wherein
the one or more processors is further configured to:
identify a position of the sensed object on the displayed image, and
control the lighting device so that a light emitting element, among the plurality of light emitting elements, that is at a location of the lower end of the display apparatus that corresponds to the identified position emits light.

11. The display apparatus of claim 1, further comprising:
a speaker,
wherein the one or more processors are further configured to:
obtain acoustic data input to the speaker, and
based on a determination that a sound is present in the obtained acoustic data, control the lighting device to emit light of a color or at a location of the lower end of the display apparatus that corresponds to the sound.

12. The display apparatus of claim 11, wherein
the one or more processors are further configured to:
obtain a direction of the sound, and
control the lighting device so that at least one light emitting element, among the plurality of light emitting elements, that corresponds to the obtained direction emits light.

13. The display apparatus of claim 1, further comprising:
at least one second light emitting element configured to emit light from a rear surface of the display apparatus, and
the one or more processors are further configured to:
control the lighting device and the at least one second light emitting element to emit light together.

14. A method of a display apparatus including a display, a lighting device including a plurality of light emitting elements configured to emit light from a lower end of the display apparatus, a memory configured to store at least one instruction, and one or more processors configured to execute the at least one instruction, the method comprising:
by the one or more processors,
controlling the display to display an image input to the one or more processors,
sensing an object in the displayed image,
obtaining position information and color information corresponding to the sensed object, and
controlling the lighting device so that at least one light emitting element, among the plurality of light emitting elements, that is at a location of the lower end of the display apparatus that corresponds to the obtained position information emits light of a color corresponding to the obtained color information.

15. A non-transitory computer readable recording medium storing a program for executing a method of a display apparatus including a display, a lighting device including a plurality of light emitting elements configured to emit light from a lower end of the display apparatus, the method comprising:
sensing an object in an image to be displayed on the display of the display apparatus;
obtaining position information and color information corresponding to the sensed object; and
generating control information configured to control the lighting device so that at least one light emitting element, among the plurality of light emitting elements, that is at a location of the lower end of the display apparatus that corresponds to the obtained position information emits light of a color corresponding to the obtained color information.
